(19) United States
(12) Patent Application Publication
(10) Pub. No.: US 2013/0026738 A1
(43) Pub. Date: Jan. 31, 2013

(54) GOLF CART FOLDING DEVICE

(71) Applicant: Gordon Liao, Tainan City (TW)

(72) Inventor: Gordon Liao, Tainan City (TW)

(21) Appl. No.: 13/193,684

(22) Filed: Jul. 29, 2011

(51) Int. Cl. B62B 3/02

(52) U.S. Cl. 280/651

(57) ABSTRACT

A golf cart folding device comprises an upper frame having a handle tube at an upper end of the upper frame; a rear wheel stand coupled to the upper frame by a connecting plate, and having a rear wheel at a lower end of the rear wheel stand; a pull rod coupled to the upper frame and the rear wheel stand; a lower frame, coupled to the upper frame, and having a front wheel at a lower end of the lower frame; and a link rod mechanism between the upper and lower frames for drawing the lower frame and the front wheel together towards the rear wheel by the linking of the link rod mechanism when a golf cart is folded, so as to achieve the effects of skipping a step of folding the front wheel, preventing making a user's body or cloth dirty, and providing a simple and easy operation.

### BACKGROUND OF THE INVENTION

1. Field of the Invention

The present invention relates to a golf cart folding device, and more particularly to the golf cart folding device capable of simultaneously drawing a front wheel and a rear wheel together to achieve the effects of skipping the step of additionally folding the front wheel, preventing making a user dirty and providing a simple and easy operation.

2. Description of the Related Art

In a conventional golf cart, it is necessary to fold a front wheel after the whole golf cart is folded, and the procedure generally carried out by the following two methods: (1) A rotating shaft is provided for turning the front wheel to draw the rear wheel together as disclosed in U.S. Pat. No. 6,698,789; and (2) The front wheel is removed, and this method of removing the front wheel requires a reinstallation of the front wheel and may cause troubles and inconvenient if the components of the front wheel are missing. In both methods, the user needs to bend or squat, and then holds the cart frame at a specific inclination by one hand and folds (or removes) the front wheel by the other hand. These methods not only involve a tedious work and a poor posture, but also cause the problem of making the user's body or cloth dirty. Obviously, the conventional way of folding the golf cart is troublesome and inconvenient, and definitely requires improvements.

### SUMMARY OF THE INVENTION

Therefore, it is a primary objective of the present invention to provide a golf cart folding device that can be operated in a simple and convenient manner. When the golf cart is folded, a front wheel and a rear wheel can be drawn together synchronously to skip the step of folding the front wheel again and preventing making the user dirty.

To achieve the aforementioned objective, the present invention comprises: an upper frame having a handle tube installed at an upper end of the upper frame; a rear wheel stand coupled to the upper frame by a connecting plate and having a rear wheel installed at a lower end of the rear wheel stand; a pull rod coupled to the upper frame and the rear wheel stand; a lower frame coupled to the upper frame and having a front wheel at a lower end of the lower frame; and a link rod mechanism installed between the upper and lower frames for drawing the lower frame and the front wheel together towards the rear wheel by the linking of the link rod mechanism when a golf cart is folded, so as to achieve the effects of skipping a step of folding the front wheel, preventing making a user's body or cloth dirty, and providing a simple and easy operation.

### BRIEF DESCRIPTION OF THE DRAWINGS

FIG. 1 is a perspective view of the present invention;

FIG. 2 is a schematic view of folding a golf cart in accordance with the present invention; and

FIG. 3 is a side view of a folded golf cart in accordance with the present invention.

### DETAILED DESCRIPTION OF THE PREFERRED EMBODIMENTS

To make it easier for our examiner to understand the technical characteristics and measures of the present invention to achieve the aforementioned objects and effects, we use preferred embodiments with related drawings for the detailed description of the present invention as follows.

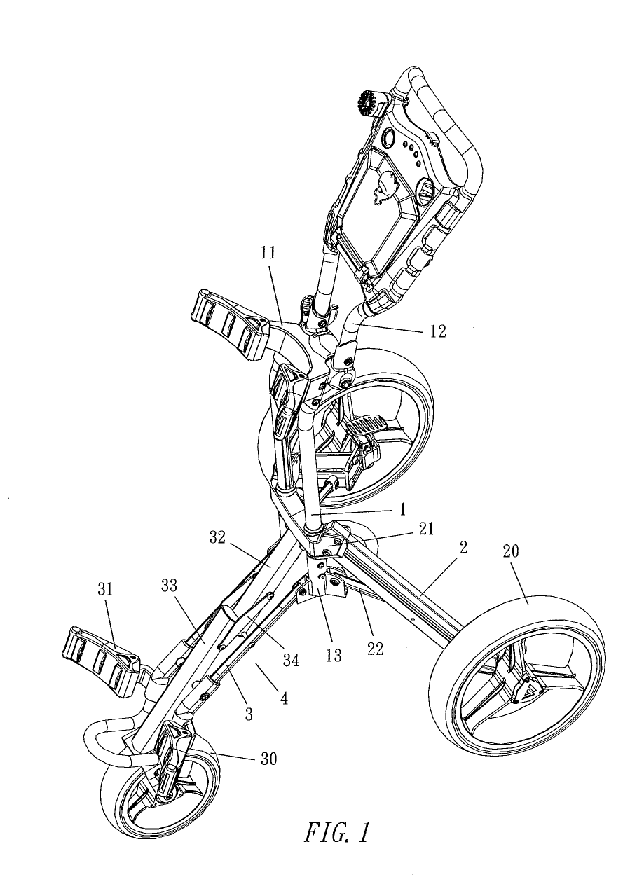

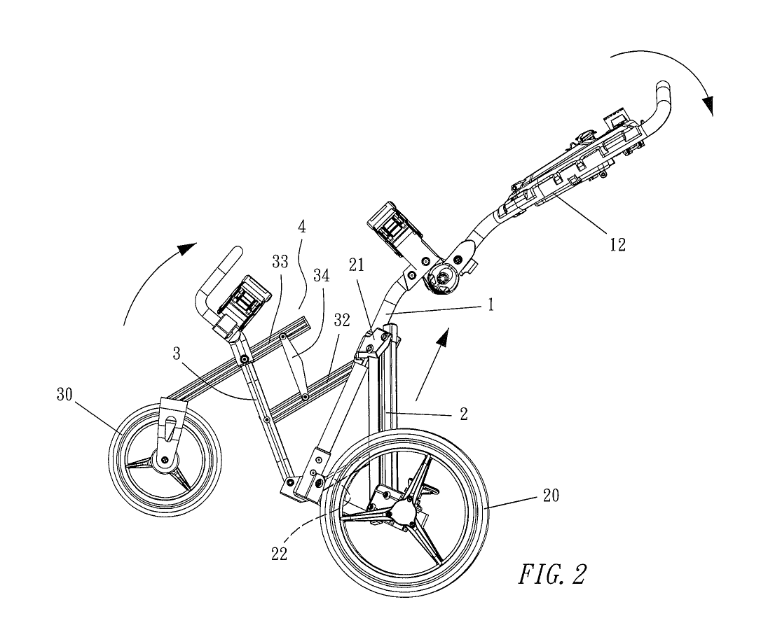

With reference to FIGS. 1 and 2, the present invention comprises:
an upper frame 1, having an upper retaining base 11 disposed at an upper end of the upper frame 1 and coupled to a handle tube 12, and an adapter 13 disposed at a bottom end of the upper frame 1;
a rear wheel stand 2, with an upper end coupled to the upper frame 1 by a connecting plate 21, and a lower end coupled to a rear wheel 20;
a pull rod 22, coupled between the bottom end of the upper frame 1 (adapter 13) and the rear wheel stand 2;
a lower frame 3, with an end coupled to the upper frame 1 (adapter 13), and another end having a lower retaining base 31, and coupled to a bottom frame 33, and an end of the bottom frame 33 coupled to the front wheel 30; and
a link rod mechanism 4, installed between the upper and lower frames 1, 3, and including: a first link rod, which is the lower frame 3; a second link rod 32, coupled between the upper and lower frames 1, 3; a third link rod, which is the bottom frame 33, coupled to the lower frame 3; a fourth link rod 34, coupled between the second and third link rods 32, 33, and the first, second, third and fourth link rods 3, 32, 33, 34 being four link rods parallel to one another.

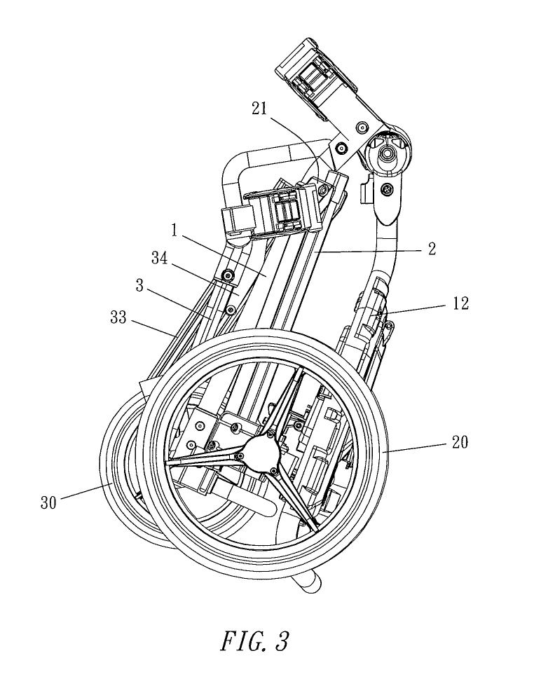

When a golf cart is folded, the lower frame 3 is lifted to push the connecting plate 21 by the second link rod 32 and pull the rear wheel stand 2, so that the rear wheel 20 is folded inwardly. On the other hand, the lower frame 3 is coupled to the third link rod 33, and another end of the third link rod 33 is coupled to the fourth link rod 34, and the lower frame 3 and the second, third and fourth link rods 32, 33, 34 are four parallel link rods, so that when the golf cart is folded, the fourth link rod 34 will remain parallel to the lower frame 3, and while the lower frame 3 is being lifted, the link of the fourth link rod 34 will fold the lower frame 3 and the third link rod 33 gradually to drive the front wheel 30 to move in a direction towards the connecting plate 21, and the front and rear wheels 30, 20 gradually approach one another as shown in FIG. 2 until the golf cart is folded, and then the upper and lower frames 1, 3 are folded and stacked with one another, and the front wheel 30 will move horizontally with the four link rod mechanisms 4 in a direction towards the rear wheel 20 as shown in FIG. 3. Now, users no longer need to perform any folding motion of the front wheel 30, and the whole golf cart will be attached and folded into a smaller storage volume.

In this preferred embodiment, when the golf cart is folded, the users simply lift the lower frame 3 to synchronously drive and draw the front wheel 30 and the rear wheel 20 together by the four link rod mechanisms 4 comprised of the lower frame 3 and the second, third and fourth link rods 32, 33, 34, and the upper and lower frames 1, 3 are folded and stacked with one another. The invention not only provides a simple and convenient operation, but also achieves the effects of skipping the step of folding the front wheel 30 again and preventing making a user's body or cloth dirty. Obviously, the invention improves over the prior art.

In short, the present invention is characterized in that: (1) The front wheel is fixed to the lower frame; (2) A link rod mechanism is installed between the upper and lower frames, such that when the golf cart is folded, the link rod mechanism can be used for folding the lower frame and drawing the front wheel and the rear wheel together synchronously to achieve the effects of skipping the step of folding the front wheel again, preventing making the user's body or cloth dirty and providing a simple and convenient operation.

While the invention has been described by means of specific embodiments, numerous modifications and variations of the link rod mechanism could be made thereto by those skilled in the art without departing from the scope and spirit of the invention set forth in the claims.

In summation of the description above, the present invention improves over the prior art and complies with the patent application requirements, and is thus duly filed for patent application.

What is claimed is:

1. A golf cart folding device, comprising:
an upper frame, having a handle tube installed at an upper end of the upper frame;
a rear wheel stand, coupled to the upper frame by a connecting plate, and having a rear wheel installed at a lower end of the rear wheel stand;
a pull rod, coupled to the upper frame and the rear wheel stand;
a lower frame, coupled to upper frame, and having a front wheel installed at a lower end of the lower frame; and
a link rod mechanism, installed between the upper and lower frames, for drawing the lower frame and the front wheel together in a direction towards the rear wheel by the linking of the link rod mechanism when a golf cart is folded, so as to achieve the effects of skipping a step of folding the front wheel, preventing making a user's body or cloth dirty, and providing a simple and easy operation.

2. The golf cart folding device of claim 1, wherein the upper frame includes an adapter installed at a bottom end of the upper frame.

3. The golf cart folding device of claim 1, wherein the link rod mechanism includes:
a lower frame, coupled to the upper frame;
a second link rod, coupled to the upper and lower frames;
a third link rod, coupled to the lower frame and the front wheel; and
a fourth link rod, coupled to the second and third link rods.
